(19) United States
(12) Patent Application Publication
(10) Pub. No.: US 2002/0145465 A1
(43) Pub. Date: Oct. 10, 2002

(54) Efficient charge pump apparatus and method for operating the same

(76) Inventors: Joseph Shor, Tel Mond (IL); Yair Sofer, Tel Aviv (IL); Eduardo Maayan, Klar Saba (IL)

Correspondence Address: EITAN, PEARL, LATZER & COHEN-ZEDEK, ONE CRYSTAL PARK, SUITE 210, 2011 CRYSTAL DRIVE, ARLINGTON, VA, 22202-3709, US

(21) Appl. No.: 09/827,512

(22) Filed: Apr. 5, 2001

(51) Int. Cl. G05F 1/10

(52) U.S. Cl. 327/536

(57) ABSTRACT

A multi-stage charge pump apparatus and a method for powering and controlling the same is presented. Each stage of the charge pump includes an energy injection capacitor and a gate control capacitor to permit the transfer and accumulation of charge through the charge pump to an output through the use of transistor switches. The charge pump is driven by a pair of clock signals where the voltage swing of the clock signal driving the control gate capacitors is advantageously set to a higher level than that of the clock signal driving the energy injection capacitor. In this manner, the effect of bulk voltages in the later stages of the charge pump is overcome.

### FIELD OF INVENTION

The present invention relates to power supplies for microelectronic devices. More particularly, the present invention relates to a novel and efficient charge pump apparatus and a method for operating the same.

### BACKGROUND

Charge pumps are known devices that are capable of generating a power supply for electronic circuitry. Charge pumps provide a controlled output voltage that is higher than the charge pump's input voltage supply.

The utilization of charge pumps has increased dramatically in recent years due to the proliferation of hand-held and miniature electronic devices. Charge pumps operate by boosting charge across a capacitor and transferring the charge from one capacitor to another and, by this process, accumulating the charge stored on each capacitor until the resulting accumulated voltage (which is higher than the input voltage) is output from the charge pump. The transfer of charge from capacitor to capacitor in a charge pump is controlled by a plurality of switch pairs usually in the form of transistors. The operation of the switch pairs, i.e., the opening and closing of the switch pairs, is controlled by out-of-phase oscillating clock signals. The timing of the switches is coordinated with capacitor boosting. The oscillating clock signals of the charge pump permit the controlled operation of the switches and facilitate the orderly transfer of voltage to the output of the charge pump.

It is known in the art to construct charge pumps in stages in order to permit the use of an increased number of capacitors in the charge pump and, therefore, to provide a greater voltage increase at the output of the last stage of the charge pump as compared to the input at the first stage of the charge pump. Thus, in a multi-stage charge pump, a relatively low charge pump input voltage yields a high output voltage. A co-pending patent application titled EFFICIENT CHARGE PUMP WITH CONSTANT BOOSTED OUTPUT VOLTAGE U.S. Serial Number to be assigned and filed on even date herewith (Attorney Docket No. 2671/01009) assigned to the present assignee, which is hereby incorporated herein by reference in its entirety, describes several embodiments of a regulator for a multi-staged charge pump.

It is also known in the art, however, that the gate-source voltage (Vgs) of any particular switch (i.e., transistor) being utilized in the charge pump must be maintained well above the threshold voltage (Vt) in order to insure proper operation. This limitation is of particular concern in multi-stage charge pumps where the body effect tends to raise the threshold voltages of the switches to very high levels, especially in the later stages of the charge pump where the bulk-source voltage (Vbs) can be very high. Such operational difficulties and inefficiencies are unavoidable where, for example, a transistor switch has a threshold voltage of between 2.5 and 3.0 volts (including body effect) and a supply voltage of 2.7 volts. In such a configuration, the transistor may be incapable of driving the required currents.

FIG. 1 illustrates a known 4-stage charge pump 100 which exhibits the above-described operational inefficiencies. Charge pump 100 utilizes four oscillating clock signals 120, 130, 140 and 150 to control the operation of the switches and to provide power to the capacitors of charge pump 100. FIG. 2 illustrates conventional oscillating clock signals 120, 130, 140 and 150 that are used to drive and power charge pump 100 of FIG. 1.

The operation of charge pump 100 is now described with reference to FIGS. 1 and 2. Oscillating clock signals 140 and 150 provide each stage of charge pump 100 with voltage for powering the charge pump across respective energy injection capacitors 360, 370, 380 and 390. Energy injection capacitors 360,370,380 and 390 provide voltage and current to the boosted output of charge pump 100. Most of the power consumed by charge pump 100 is associated with the current flow through energy injector capacitors 360, 370, 380 and 390.

The charge stored across energy injection capacitors 360, 370, 380 and 390 is respectively transferred across nodes 320, 330, 340 and 350 toward the output 400 of charge pump 100. The transfer of charge across nodes 320, 330, 340 and 350 is controlled by the joint operation of transistor pairs (200, 280), (210, 290), (220,300) and (230, 310). The operation of the transistor pairs is, in turn, controlled by oscillating clock signals 120 and 130. The maximum voltage of oscillating clock signals 120 and 130 is equal to that of oscillating clock signals 140 and 150. Moreover, gate control capacitors 160, 170, 180 and 190, which are connected in series with respective oscillating clock signals 120 and 130, are utilized only to turn the transistor pairs on and off—in accordance with the operation of clock signals 120 and 130—and, therefore, are selected to have a capacitive value that is significantly less than (by a factor ranging from 5 to 10) that of energy injection capacitors 360, 370, 380 and 390.

With continued reference to FIGS. 1 and 2, the operation of stage 1 (110) of charge pump 100 is now described. At t₀, oscillating clock signal 140 rises toward maximum voltage. Transistors 280 and 290 are now non-conducting because oscillating clock signals 120 and 130 (which provide supply voltage to switches 280 and 290) are low. (See FIG. 2). Node 320 is now charged by oscillating clock signal 140 across energy injection capacitor 360. The charge at node 320 boosts the voltage at the gate of transistor 200 thereby driving V_{DD} to the gate of transistor 240. The gate-source voltage (Vgs) of transistor 240 is now zero and the transistor is in a non-conducting state.

With continued reference to FIGS. 1 and 2, several nanoseconds after the oscillating clock signal 140 arrives at maximum voltage, oscillating clock signal 120 begins its rise to maximum voltage which causes transistor 290 to become conducting and therefore allows the transfer of the charge stored on node 320 to node 330 of stage 2 (410) of charge pump 100.

The process described above with reference to stage 1 (110) of charge pump 100 occurs simultaneously at each of the four stages of charge pump 100 through utilization of the respective oscillating clock signals 120, 130, 140 and 150. In this manner, charge is transferred and accumulated along each node 320, 330, 340 and 350 of charge pump 100 to provide a continuous amplified voltage at 400.

It is known that in the above-described prior art system and method as illustrated in FIGS. 1 and 2, the voltage at each of nodes 240, 250, 260 and 270 experiences an accumulated increase of V_{DD} during charge transfer from node to node. This successive increase causes a large voltage bulk effect in the later stages of charge pump 100 which thereby raises the threshold voltage of the switch pairs (200, 280), (210, 290), (220, 300) and (230, 310). (The increase in threshold voltage is due to the fact that the bulk nodes of the transistor pairs are at ground and, as such, have a large bulk-source voltage (Vbs).) The rise in threshold voltage significantly reduces the efficiency of the charge transfer process and, thus, the overall efficiency of charge pump 100. Attempts to raise the bulk voltage in order to reduce the effect of the rise in threshold value involves the risk that the switches may latchup due to forward biasing of bulk-source and bulk-drain diodes. Alternately, charge pump 100 may be depleted of charge as a result of an undesired bipolar action in the switches of the later stages when the diodes are forward biased. Additionally, in most CMOS processes, it is not possible to provide NMOS transistors with a bulk bias above ground level.

U.S. Pat. No. 6,064,251 of Park et al., which is hereby incorporated herein by reference in its entirety, attempts to remedy the above-described drawbacks relating to bulk effect charge transfer by providing an 8-stage charge pump wherein the first four stages of the charge pump are powered by oscillating clock signals having a voltage swing of V_{DD} while the last four stages of the charge pump are powered by a boosting oscillating clock signals having a voltage swing of 2×V_{DD}. In this manner, the later stages of the charge pump are provided with a boosting voltage that is sufficiently higher than the threshold voltage of the late-stage switches, thus allowing charge transfer across the charge pump.

Unfortunately, the high voltage boosting oscillating clock signals of the later stages result in an energy inefficiency because both the energy injection capacitors and the gate control capacitors (and their respective parasitic constituencies) are charged by the 2×V_{DD} oscillating clock signal. While the charge stored across the energy injection capacitor is utilized and eventually transferred to the output, the charge stored across the parasitic capacitance of the energy injection capacitor as well as the charge stored across the parasitic capacitance of the gate control capacitor are connected to ground and are, therefore, wasted. The current transferred through the parasitic capacitors can account for 30%-60% of the total current transferred into the charge pump.

What is desired therefore and has heretofore been unavailable is a multi-stage charge pump that compensates for threshold voltage drops along the stages of the charge pump while limiting the boosting signal so to conserve energy and improve charge transfer efficiency through the charge pump.

### SUMMARY OF THE INVENTION

According to a first aspect of the present invention, an improved charge pump is provided of the type including a plurality of stages, each stage having an input and an output, an energy injection capacitor and a control capacitor, the improvement including: a) first clock signal having a first voltage swing, the first clock signal being applied to the energy injection capacitors of each of the stages; and b) second clock signal having a second voltage swing greater than the first voltage swing, the second clock signal being applied to the control capacitor of at least one of the stages.

In a more specific embodiment of the present invention, the second voltage swing of the second clock signal of the improved charge pump is sufficient to compensate for threshold voltage losses in the stages to which it is applied.

In a more specific embodiment of the present invention, the improved charge pump includes at each stage, a charge transfer transistor and a controlling transistor, wherein: (a) the energy injection capacitor has a first terminal coupled to the output of a given stage and the input of a subsequent stage and has a second terminal coupled to one phase of the first clock signal; (b)the charge transfer transistor has three terminals including a first terminal coupled to a third terminal of the control transistor, a second terminal coupled to the input of the given stage, and a third terminal coupled to the output of a given stage; (c) the controlling transistor has three terminals including a first terminal coupled to the output of a given stage, a second terminal coupled to the input of a given stage and a third terminal coupled to the first terminal of the control capacitor and also to the first terminal of the charge transfer transistor; and (d) the control capacitor has a second terminal coupled to one of the phases of the second clock signal.

In another aspect of the present invention, a method is provided for overcoming increasing bulk effect in successive stages of a charge pump by applying in a given stage an energizing voltage to an energy injection capacitor while applying a comparatively greater voltage to a control capacitor.

### BRIEF DESCRIPTION OF THE DRAWINGS

Other objects and features of the present invention will be described hereinafter in detail by way of certain preferred embodiments with reference to the accompanying drawings, in which:

FIG. 1 illustrates a prior art 4-stage charge pump;

FIG. 2 illustrates prior art oscillating clock signals that power and control the prior art 4-stage charge pump of FIG. 1;

FIG. 3 illustrates a first preferred embodiment of the improved charge pump of the present invention;

FIG. 4 illustrates oscillating clock signals that power and control the improved charge pump of FIG. 3;

FIG. 5 illustrates a second preferred embodiment of the improved charge pump of the present invention; and

FIG. 6 illustrates oscillating clock signals that power and control the improved charge pump of FIG. 5.

### DETAILED DESCRIPTION OF THE PREFERRED EMBODIMENTS

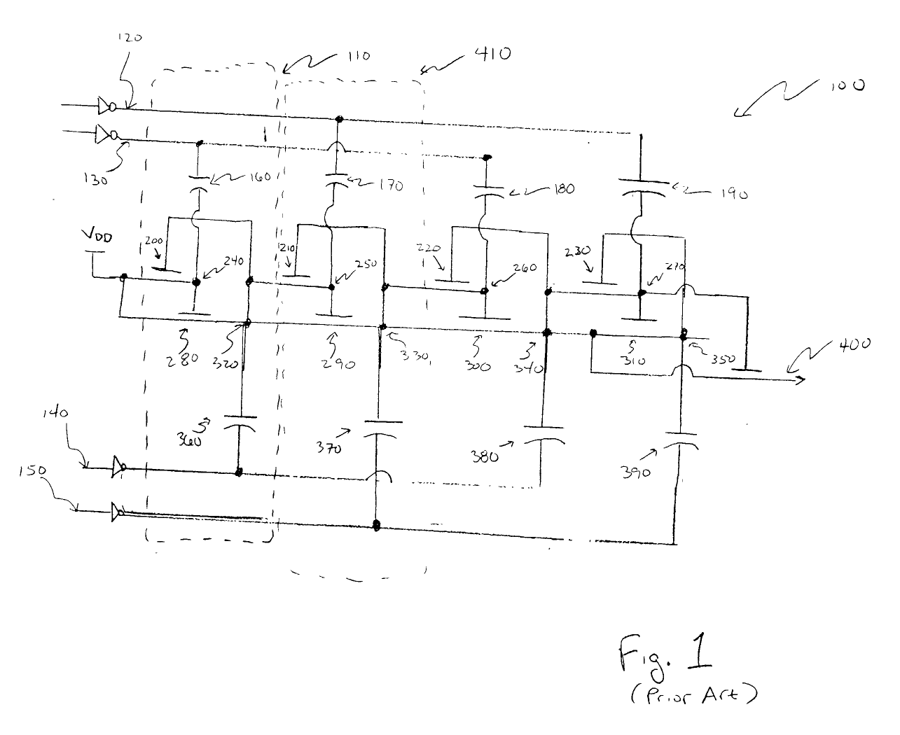

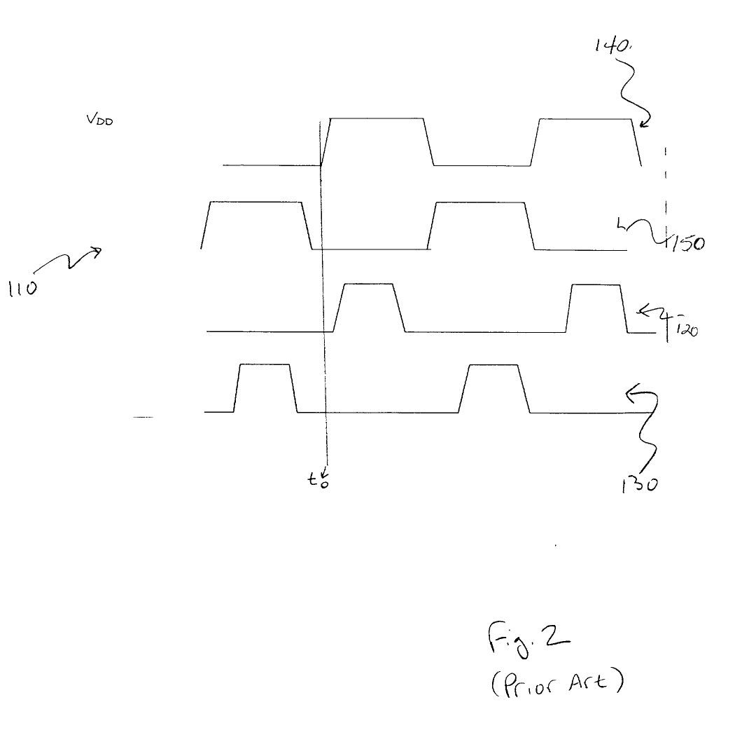

The present invention is an improvement of the prior art charge pumps that are described above in FIGS. 1 and 2 and in U.S. Pat. No. 6,064,251 of Park et al. As will be described in greater detail below, the improvement is preferably embodied as a method and apparatus for charging the gate control capacitors of the charge pump of the present invention with an oscillating signal clock that has a greater voltage swing than that applied to the energy injection capacitors in order to operate the charge pump at greater efficiency. Although the present invention is described as an improvement with reference to the prior art devices, it is understood that the scope of the claimed invention is limited only by the language of the claims and is in no way restricted to, or by, the structure, design and/or operation of either the prior art devices described above or the preferred embodiments described below.

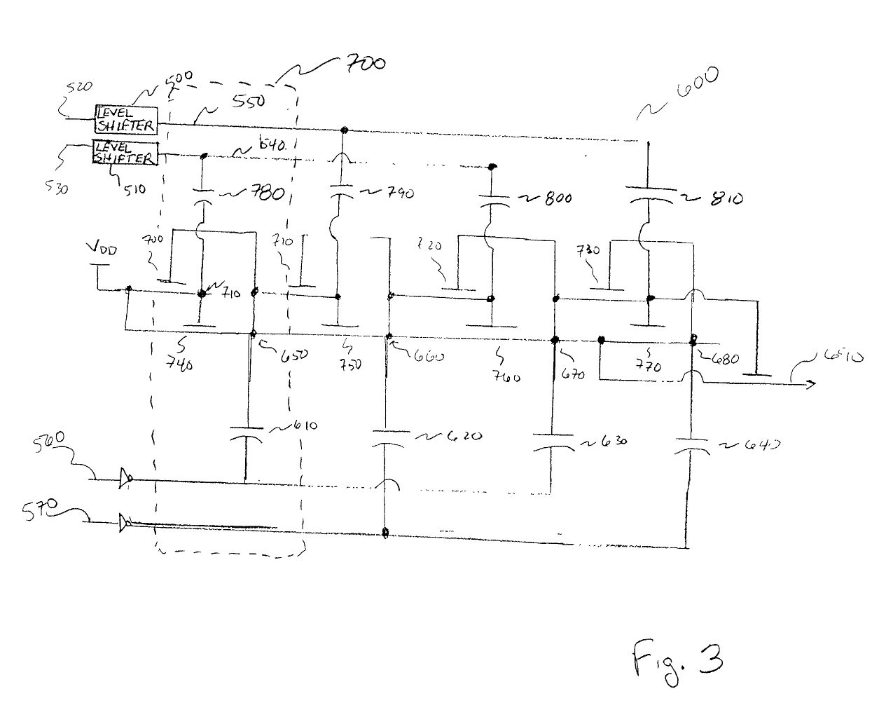

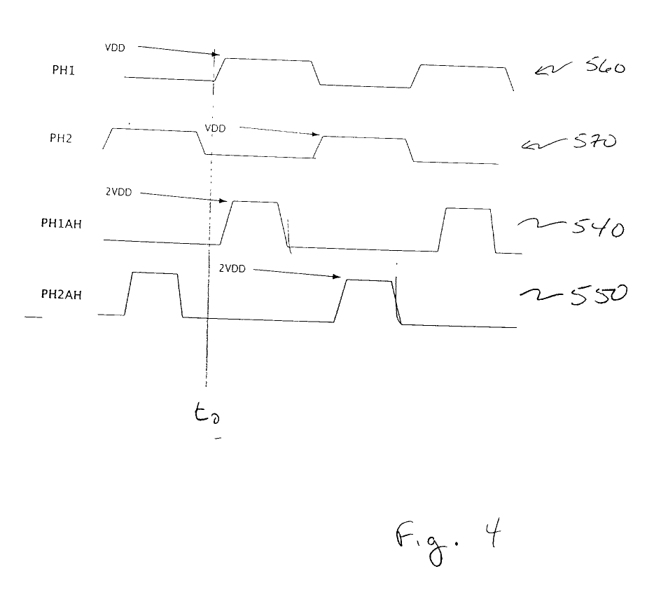

FIG. 3 illustrates a first preferred embodiment of a charge pump 600 of the present invention. FIG. 4 illustrates the oscillating clock signals 540, 550, 560 and 570 for controlling and powering the charge pump illustrated in FIG. 3.

Charge pump 600 includes level shifters 500 and 510 which provide a clock signal, including oscillating clock signals 540 and 550, to the gate control capacitors of charge pump 600. As further illustrated in FIG. 4, oscillating clock signals 540 and 550, have a voltage swing larger than V_{DD}, i.e., for example, 2×V_{DD}. It is understood that the exact value of the voltage swing of oscillating clock signals 540 and 550 is not critical. As will be explained further below, the voltage swing of oscillating clock signals 540 and 550 is limited only insofar as it must be greater than the sum of the gate voltage (Vg) and threshold voltage (Vt) of the back-biased control transistors along charge pump 600.

The operation of the first preferred embodiment of the charge pump of the present invention will now be described with reference to FIG. 3 and oscillating clock signals 540, 550, 560 and 570 of FIG. 4.

A first clock signal, illustrated as oscillating clock signals 560 and 570 in FIGS. 3 and 4, provide each stage of charge pump 600 with voltage for powering the charge pump across respective energy injection capacitors 610, 620, 630 and 640. The charges stored across energy injection capacitors 610, 620, 630 and 640 are respectively transferred across nodes 650, 660, 670 and 680 toward the output 690 of charge pump 600. The transfer of charge across nodes 650, 660, 670 and 680 is controlled by the joint operation of transistor pairs (700, 740), (710, 750), (720, 760) and (730, 770) where transistors 700, 710, 720 and 730 operate as control transistors and transistors 740, 750, 760 and 770 operate as charge transfer transistors. Transistors are referred to alternately herein as switches.

The operation of transistors pairs (700, 740), (710, 750), (720, 760) and (730, 770) is, in turn, controlled by a second clock signal, illustrated as oscillating clock signals 540 and 550 in FIGS. 3 and 4. As will be described, oscillating clock signals 540 and 550 also serve to drive the transistors above their respective threshold values in order to insure charge transfer. In the preferred embodiment the voltage swing of the second clock signal, i.e., oscillating clock signals 540 and 550, is greater than that of the first clock signal, i.e., oscillating clock signals 560 and 570. The voltage swing of the first clock signal is preferably V_{DD} while the voltage swing of the second clock signal is greater than that of the first signal, e.g., 2×V_{DD} or (V_{DD}+Vt). Moreover, gate control capacitors 780, 790, 800 and 810, which are connected in series with respective oscillating clock signals 540 and 550, have a capacitive value that is significantly less than that of energy injection capacitors 610, 620,630 and 640. In the preferred embodiment, the capacitive values of gate control capacitors 780, 790,800 and 810 are ⅕ (one-fifth) that of energy injection capacitors 610,620,630 and 640. Thus, the boosting of the clock signals 540 and 550 requires significantly less power than the boosting of clock signals 560, 570 since there is considerably less parasitic capacitance at issue.

With continued reference to FIGS. 3 and 4, the operation of stage 1 (700) of charge pump 600 will now be described. At t₀, oscillating clock signal 560 rises toward maximum voltage. Transistors 740 and 750 are now non-conducting because oscillating clock signals 540 and 550 (which provide supply voltage to switches 740 and 750) are low. Node 650 is now charged by oscillating clock signal 560 across energy injection capacitor 610. The voltage at node 650 forces node 710 to V_{DD} (through transistor 700) which maintains transistor 740 in a non-conducting state.

With continued reference to FIGS. 3 and 4, several nanoseconds after the oscillating clock signal 560 arrives at maximum voltage, oscillating clock signal 540 begins its rise to maximum voltage which causes transistor 750 to become conducting and therefore allows the transfer of the charge stored on node 650 to node 660.

The above-described process occurs simultaneously at each of the four stages of charge pump 600 through utilization of the respective oscillating clock signals 540, 550, 560 and 570. In this manner, charge is transferred and accumulated along each node 650, 660, 670 and 680 of charge pump 600 to provide a continuous amplified voltage at output 690.

The voltage at each of nodes 650,660,670 and 680 is increased by V_{DD} during charge transfer causing a large voltage bulk effect in the later stages of charge pump 600 because the bulk-stage (Vbs) is high as the bulk is grounded. Accordingly, threshold voltages of the transistors 700-770 rise. However, as illustrated in FIG. 4, the oscillating clock signals 540 and 550 provided to the gate control capacitors 780, 790, 800 and 810 preferably have a value larger than V_{DD}—sufficient to overcome the large threshold voltages in the later stages of charge pump 600. By providing the gate controlled capacitors 780,790, 800 and 810 with boosted oscillating clock signals 540 and 550, a greater efficiency is achieved over the prior art charge pump of FIG. 1. Moreover, by providing the energy injection capacitors with non-boosted oscillating clock signals 560 and 570, the inefficiencies associated with the teachings of U.S. Pat. No. 6,064,251, as described above, are avoided, namely, the loss of current across the parasitic capacitive components of the respective energy injection capacitors.

In a preferred embodiment, as illustrated in FIG. 4, the respective phases of oscillating clock signals 560 and 570 have non-overlapping pulse durations. Similarly, the respective phases of oscillating clock signals 540 and 550 also have non-overlapping pulse durations. Moreover, because oscillating clock signals 540 and 550 rise and fall while oscillating clock signals 560 and 570 are respectively high, oscillating clock signals 540 and 550 are enveloped by oscillating clock signals 560 and 570.

One skilled in the art will appreciate that boosted oscillating clock signals 540 and 550 may be generated by any of the various methods known in the art. As illustrated in FIG. 3, boosted oscillating clock signals 540 and 550 is provided by an auxiliary charge pump (not shown), the output of which is then fed through level shifters 510 and 500, respectively. Alternately, boosted oscillating clock signals 540 and 550 can be generated using a boot-strapped stage.

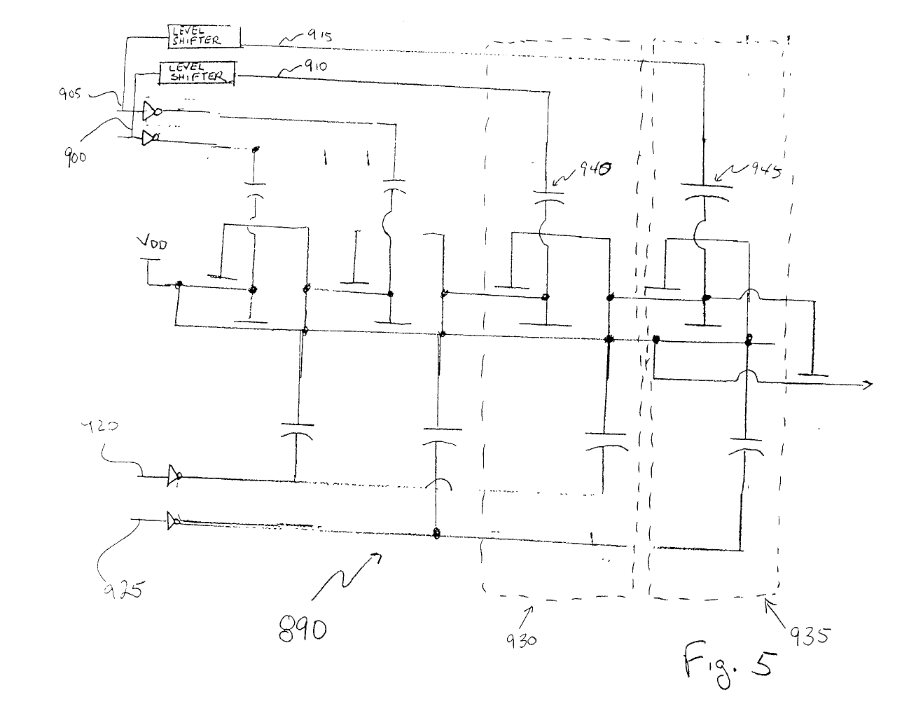

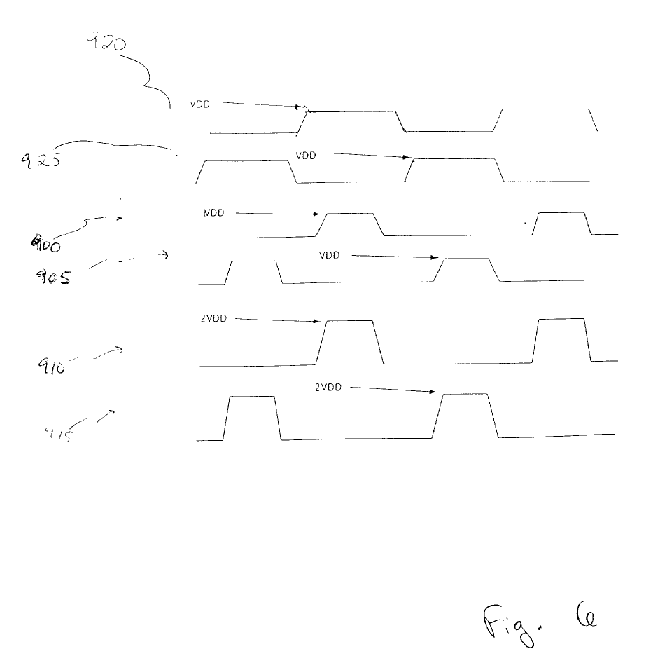

Further efficiencies are realized in the preferred embodiment of the present invention illustrated in FIG. 5 wherein a four-stage charge pump 890 generally configured in a manner similar to charge pump 600 of FIG. 3 is shown. As shown in FIG. 5 and the accompanying signal diagrams of FIG. 6, charge pump 890 differs from charge pump 600 in that only the later two stages (stage 3 (930) and stage 4 (935)) receive a boosted oscillating clock signal (910 and 915, respectively) which is applied to gate control capacitors 940 and 945. In this manner, further efficiency is achieved over that of the operation of charge pump 600 in that only in those transistors where the threshold voltage are the largest (i.e., in the later stages of the charge pump) is the gate voltage boosted. In a preferred embodiment, oscillating clock signals 900 and 910 and oscillating clock signals 905 and 915 have the same phase but, as described above and as illustrated in FIG. 6, operate with different voltage swings, preferably V_{DD} and 2×V_{DD}. In principle, the arrangement of FIG. 5 shows that the inventive concept can be selectively applied to one or more stages, as required, to overcome an increasing bulk effect in a charge pump.

As one skilled in the art will readily appreciate, where the above-described charge pumps utilize Field Effect Transistors (FETs), such FETs are symmetrical components with respect to the described source and drain terminals. The designation of the respective terminals as source or drain are determined by the relative voltages present on the terminals where the drain terminal is always the higher of the two. At any point in time in a given charge pump stage, the voltage at the two respective terminals is alternatively the higher or the lower voltage of the two depending on the state of clock cycle. Thus the designation of source and drain in the above-described preferred embodiments is understood to be context dependent and interchangeable, and the above description of the preferred invention is not, therefore, meant to limit the scope of the claimed invention with respect to the choice of transistor utilized or the operation of the transistors.

One skilled in the art will appreciate that many variations on the above-described preferred embodiments may be realized without departing from the scope of the present claims. The values of the capacitors utilized in the described charge pumps may vary depending upon operating conditions and design preference. The switches utilized may be transistors of any type, e.g., MOS devices, and may be variously configured to achieve the described result. As one skilled in the art will understand, n-MOS or p-MOS devices may be utilized to realize a positive or negative output charge pump. Moreover, the phase of the clock signals utilized may be varied as may the voltage swings of the clock signals utilized. The number of stages utilized may exceed the number described above while the application of the clock signal with the greater voltage swing may be limited to one or to any multiplicity of stages.

1. In a charge pump of the type including a plurality of stages, each stage comprising an input and an output, an energy injection capacitor and a control capacitor, the improvement comprising:
a) a first clock signal having a first voltage swing, the first clock signal being applied to the energy injection capacitors of each of the stages; and
b) a second clock signal having a second voltage swing greater than the first voltage swing, the second clock signal being applied to the control capacitor of at least one of the stages.

2. The charge pump as in claim 1, wherein the second voltage swing of the second clock signal is sufficient to compensate for threshold voltage losses in the stages to which it is applied.

3. The charge pump as in claim 1, wherein the second clock signal is applied to a subset of the stages and the first clock signal is applied to a remainder of the stages.

4. The charge pump as in claim 1, wherein the first clock signal includes two distinct pulse trains having respective first and second phases, and wherein the second clock signal includes two distinct pulse trains having respective first and second phases.

5. The charge pump as in claim 4, wherein the first and second phases of the first clock signal have non-overlapping pulse durations, and wherein first and second phases of the second clock signal have non-overlapping pulse durations.

6. The charge pump as in claim 1, wherein an operative portion of the first phase of the first clock signal coincides with an operative portion of the first phase of the second clock signal, and wherein an operative portion of the second phase of the first clock signal coincides with an operative portion of the second phase of the second clock signal.

7. The charge pump as in claim 6, wherein the operative portion of the first phase of the first clock signal envelops the operative portion of the first phase of the second clock signal, and wherein the operative portion of the second phase of the first clock signal envelops the operative portion of the second phase of the second clock signal.

8. The charge pump as in claim 1, further comprising at each stage a charge transfer transistor and a controlling transistor, wherein:
(a) the energy injection capacitor has a first terminal coupled to the output of a given stage and the input of a subsequent stage and has a second terminal coupled to the first clock signal,
(b) the charge transfer transistor has three terminals including a first terminal coupled to a third terminal of the control transistor, a second terminal coupled to the input of the given stage, and a third terminal coupled to the output of a given stage,
(c) the controlling transistor has three terminals including a first terminal coupled to the output of a given stage, a second terminal coupled to the input of a given stage and the third terminal coupled to a first terminal of the control capacitor and also to the first terminal of the charge transfer transistor, and
(d) the control capacitor has a second terminal coupled to the second clock signal.

9. The charge pump as in claim 8, wherein all of the transistors in a given stage are either n-mos devices or p-mos devices.

10. The charge pump as in claim 9, wherein the charge transfer transistor and the controlling transistor are MOS devices, and wherein the first, second and third terminals of the MOS devices are the gate, source and drain terminals, respectively.

11. The charge pump as in claim 1, wherein the charge pump is either a positive charge pump or a negative charge pump.

12. A method for overcoming increasing bulk effect in successive stages of a charge pump by applying in a given stage an energizing voltage to an energy injection capacitor while applying a comparatively greater voltage to a control capacitor.
